(19) United States
(12) Patent Application Publication
(10) Pub. No.: US 2009/0259497 A1
(43) Pub. Date: Oct. 15, 2009

(54) METHOD OF MANAGING AN INSURANCE PLAN AND A SYSTEM THEREFOR

(76) Inventors: Adrian Gore, Houghton Estate (ZA); Herschel Phillip Mayers, Johannesburg (ZA); Kenneth Steven Rabson, Johannesburg (ZA)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 12/303,388

(22) PCT Filed: May 23, 2007
(86) PCT No.: PCT/IB07/51948

§ 371 Date: Dec. 4, 2008

(30) Foreign Application Priority Data
Jun. 6, 2006 (ZA) 2006/04687

(51) Int. Cl. G06Q 40/00

(52) U.S. Cl. 705/4; 705/14.27

(57) ABSTRACT

A method of managing a life or health insurance plan includes calculating an amount of expenditure of a member using a credit or debit card issued to the member and then using the calculated amount of expenditure to calculate a premium payable by the member, wherein the premium is reduced by a percentage of the amount of expenditure of the member using the credit or debit card issued to the member.

### BACKGROUND OF THE INVENTION

The present invention relates to a method of managing an insurance plan such as a life insurance or a health insurance plan, for example and a system therefor.

Conventionally, life insurance plans operate on the basis that an insured person, sometimes referred to as an insured life, pays a premium to the life insurer, and the life insurer pays a predetermined sum, referred to as the sum assured, to the insured life or his/her beneficiary on the occurrence of an insured event. Typical insured events are the insured life suffering disability, contracting a dread disease or dying.

Health insurance policies operate where the provider of the medical scheme undertakes liability in return for a premium or contribution and provides to members who pay such premiums or make such contributions, relevant health services and or assistance in defraying expenses incurred in connection with rendering such relevant health services.

The present invention provides a system and method of calculating a premium paid by the insured person.

### SUMMARY OF THE INVENTION

According to one example embodiment there is provided, a method of managing an insurance plan, the method including:
calculating an amount of expenditure of a member using a credit or debit card issued to the member; and
using the calculated amount of expenditure to calculate a premium payable by the member, wherein the premium is reduced by a percentage of the amount of expenditure of the member using the credit or debit card issued to the member.

The method may further include calculating a number of points earned by the member in an incentive programme operated by the insurer or a third party, wherein the percentage used to reduce the premium amount is determined based on the number of points earned in the incentive programme.

According to another example embodiment there is further provided an electronic system for managing an insurance plan includes:
a calculating module to calculate an amount of expenditure of a member using a credit or debit card Issued to the member; and
a premium module to use the calculated amount of expenditure to calculate a premium, wherein the premium amount is reduced by a percentage of the amount of expenditure of the member using the credit or debit card issued to the member.

The system may include an incentive scheme points calculating module to calculate a number of points earned by the member in an incentive programme operated by the insurer or a third party, wherein the percentage used to reduce the premium amount is determined based on the number of points earned in the incentive programme.

### BRIEF DESCRIPTION OF THE DRAWINGS

FIG. 1 is a flow chart illustrating the methodology of an example embodiment; and

FIG. 2 is a block diagram illustrating an example system to implement the methodologies described herein.

### DESCRIPTION OF EMBODIMENTS

The invention finds application in the field of managing an insurance plan such as a life insurance plan or a health insurance plan to name but a few examples.

The present invention may be implemented by a traditional life or health insurance plan operator for its members or may be implemented by another party.

Conventionally, life insurance plans operate on the basis that an insured person, sometimes referred to as an insured life, pays a premium to the life insurer, and the life insurer pays a predetermined sum, referred to as the sum assured, to the insured life or his/her beneficiary on the occurrence of an insured event. Typical insured events are the insured life suffering disability, contracting a dread disease or dying.

Health insurance policies operate where the provider of the medical scheme undertakes liability in return for a premium or contribution and provides to members who pay such premiums or make such contributions, relevant health services and or assistance in defraying expenses incurred in connection with rendering such relevant health services.

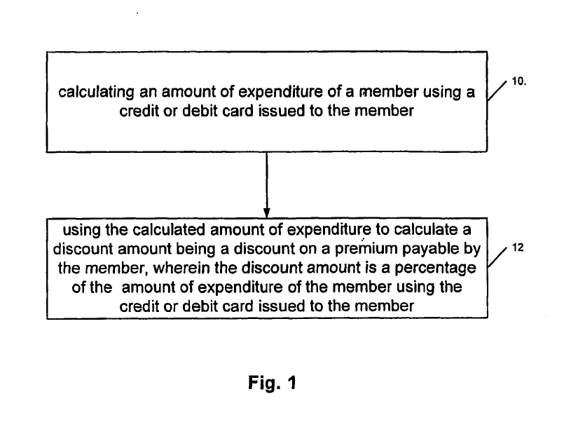

Referring to FIG. 1, in an example embodiment, the amount of expenditure made by the member on a debit or credit card issued to the member is calculated (block 10).

The credit or debit card could be a debit or credit card of a third party financial institution that may or may not be branded by the insurer. Alternatively, the credit or debit card could be issued by the insurer itself.

Based on the calculated expenditure amount of the member using the credit or debit card issued to the member, the member is given a discount on their premiums for the insurance plan. The amount is typically calculated as a percentage of the total spent on the credit or debit card in a given period (block 12).

The method may further include calculating a number of points earned by the member in an incentive program operated by the insurer or a third party, wherein the percentage used to determine the discount is determined based on the number of points earned in the incentive program.

An example of such an incentive program is presently managed by the applicant which manages a traditional life and health insurance plan together with their so-called Vitality™ program disclosed in the applicant's co-pending US patent publication number 09/982,274, the contents of which are incorporated herein by reference.

The Vitality program rewards members for utilizing approved related facilities and/or services. For example, members are rewarded for utilizing gymnasiums, Smoke Enders™ and Weighless™.

Members are rewarded by a points allocation system and depending on the total number of points allocated to a member, they fall within one of four statuses. In the implementation of the Vitality program, these statuses have been named in ascending order of value, blue, bronze, silver and gold. All members are placed initially in the blue status. Once a member has accumulated a predetermined number of points, his/her Vitality status is upgraded to the next appropriate level.

Using the above in an example leads to the following:

Annual adjustments are made to the discounted premiums to allow for actual Card spend.

TABLE 1
Annual adjustment based on actual Card spend and Vitality Status

| Average Monthly | | | | |
|---|---|---|---|---|
| Spend (Rand) | Blue | Bronze | Silver | Gold |
| 0-1000 | 7.50% | 7.50% | 7.50% | 7.50% |
| 1001-2000 | 3.25% | 3.25% | 3.25% | 3.25% |
| 2001-3000 | 2.50% | 2.00% | 1.75% | 1.25% |
| 3001-4000 | 1.50% | 1.25% | 1.00% | 0.75% |
| 4001-5000 | 1.00% | 0.75% | 0.25% | 0.25% |
| 5001-7500 | 0.50% | 0.25% | 0.25% | 0.25% |
| 7501-12500 | 0.00% | −0.50% | −0.50% | −0.50% |

These percentages could obviously vary depending on a number of operational, competitive and commercial factors.

It will be appreciated that by simply making purchases on their credit card or debit cards, members make their life and/or health cover more affordable by earning themselves a discount on their insurance plans.

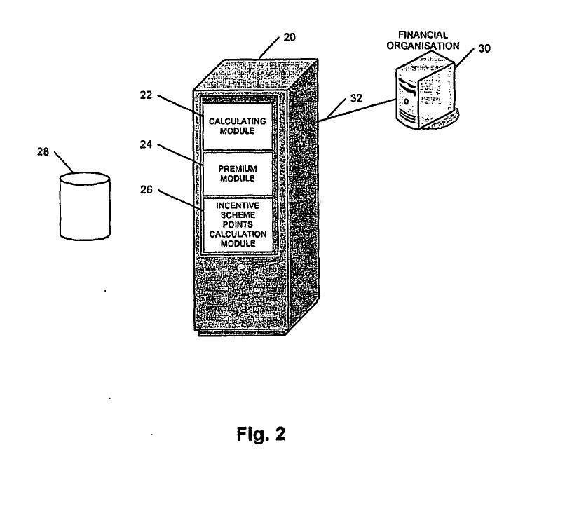

FIG. 2 illustrates an exemplary system for implementing the above methodologies.

A server 20 is typically operated by the managers of an insurance plan. The server includes a calculating module 22 to calculate an amount of expenditure of a member using a credit or debit card issued to the member.

The server also includes a premium module 24 to calculate a premium available to a member.

As has been described above, the amount of a reduction in the premium is a percentage of the amount of expenditure of the member using the credit or debit card issued to the member.

An incentive scheme points calculating module 26 is used to calculate a number of points earned by the member in an incentive programme operated by the insurer or third party administrator of the insurance plan, wherein the percentage used to determine the amount of the increase of the funds in the medical savings account is determined based on the number of points earned in the incentive programme.

The system may include a database 28 for storing information to allow the methodologies to be implemented.

Further, a server 30 of a financial institution is connected via a communications network 32 to the server 20. This may be necessary where the debit or credit card of the member is a debit or credit card of a third party financial institution.

The modules described above may be implemented by a machine-readable medium embodying instructions which, when executed by a machine, cause the machine to perform any of the methods described above.

It will be appreciated that embodiments of the present invention are not limited to such architecture, and could equally well find application in a distributed, or peer-to-peer, architecture system. Thus the modules illustrated could be located on one or more servers operated by one or more institutions.

1. A method of managing an insurance plan, the method including:
calculating an amount of expenditure of a member using a credit or debit card issued to the member; and
using the calculated amount of expenditure to calculate a premium payable by the member, wherein the premium is reduced by a percentage of the amount of expenditure of the member using the credit or debit card issued to the member.

2. A method according to claim 1 further including calculating a number of points earned by the member in an incentive programme operated by the insurer or a third party, wherein the percentage used to reduce the premium amount is determined based on the number of points earned in the incentive programme,

3. An electronic system for managing an insurance plan includes:
a calculating module to calculate an amount of expenditure of a member using a credit or debit card issued to the member; and
a premium module to use the calculated amount of expenditure to calculate a premium, wherein the premium amount is reduced by a percentage of the amount of expenditure of the member using the credit or debit card issued to the member.

4. A system according to claim 3 further including an incentive scheme points calculating module to calculate a number of points earned by the member in an incentive programme operated by the insurer or a third party, wherein the percentage used to reduce the premium amount is determined based on the number of points earned in the incentive programme.
